(19) United States
(12) Patent Application Publication
(10) Pub. No.: US 2020/0078149 A1
(43) Pub. Date: Mar. 12, 2020

(54) Expandable Floss with Specialized Tray

(71) Applicants: Mohammad Ali Saghiri, Pleasanton, CA (US); Ali Mohammad Saghiri, Tehran (IR); Soroush Ershadifar, Pleasanton, CA (US)

(72) Inventors: Mohammad Ali Saghiri, Pleasanton, CA (US); Ali Mohammad Saghiri, Tehran (IR); Soroush Ershadifar, Pleasanton, CA (US)

(21) Appl. No.: 16/125,662

(22) Filed: Sep. 8, 2018

(51) Int. Cl. A61C 15/04

(52) U.S. Cl. CPC A61C 15/041; A61C 15/043

(57) ABSTRACT

The proposed invention is floss comprised of a multifilament thread and coating that enables its expansion and increased retention to plaques. The expansion of the floss is enabled by a having a hydrophobic core with a hydrophilic coating that expands through coming in contact with saliva. Furthermore, the coating could include therapeutic agents with medicinal benefits to users, such as anti-inflammation. The filaments within the thread are compressed into thread with hexagram cross-section. Additionally, the floss is delivered through a specialized case which isolates the floss from outside air and moisture. Furthermore, the tray features U-shape terminal for oral use, in addition to a horizontal cylinder holding the floss.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field of the Invention

[0001.] The present invention relates generally to the floss comprised of a multifilament thread and coating that enables its expansion and increased retention to plaques.

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Cleaning and preventing tooth decay and periodontitis is not solely reached with brushing teeth in the recommended methods. Toothbrush has the ability to clear plaques extensively on the surfaces, while the gaps remain untouched. Studies demonstrate that regular brushing only reaches 60-70% of teeth surfaces, resulting in the accumulation of plaques in the unaffected areas. Consequently, various tools exist that help to clear up interdental spaces, with dental floss being the most common method. However, effective use of the common dental floss requires time and training. Subsequently, researches have reported that ineffective flossing fails to remove plaques from the surface and preventing damage. Furthermore, incorrect flossing could cause abrasions and physical damage to gums. The fixed width of floss demands more pressure to be exerted in the interdental space which would subsequently result in inflammation in gums. Furthermore, the lack of elasticity compiled with the fixed width could result in damage to gingival tissue and the pocket, especially at hard contact points, which are painful and could result in bleeding. Additionally, incorrect flossing could further push plaque underneath gums, leading to buildups. Traditional method of flossing also creates an unpleasant experience for the user due to pressure exerted around the finger. However, traditional floss also offers advantages; the hard wax-core of the floss and narrowness contribute to its reachability into narrow interdental spaces. On the other hand, these features could also contribute to its shortcomings, pushing bacteria and plaque further into pockets and becoming saturated with bacteria. Thus, a new improved floss must incorporate essential features such as reachability and narrowness while addressing the issues of traditional methods.

In case of EP 3 247 857 refers to dental floss comprised of two wounded tapes, giving it a softer surface. This makes it harder to clear the surfaces due to lower physical tension and pushing the bacteria and plaque to interior of the pockets. Furthermore, the inelasticity and fixed cross section make it harder to clear the interior pockets.

EP 0 662 388 cites the usage of high tensile strength polyethylene. This floss comprises a uniform filament of polyethylene. These properties give it the ability to be fully extended before rupturing, making it uncomfortable to hold and ineffective in clearing plaques due to its extension and smaller cross section.

Through EP 8 578 949 it is established the formation of a multi-textured floss with different segments that have different textures. This has led to creation of expandable flosses that are more effective in clearing plaques. The segmented expandable however are hard to use due to correct alignment of the expanding segments and opened segments getting stuck in interdental cavities.

None of these prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

In order to solve the above problems, the utility model proposes a floss with a hydrophobic core that has a fixed surface area, encapsulated by a hydrophilic coating that expands as it comes in contact with saliva. The expansion of the floss occurs in the interdental cavities after being placed for a short period of time by the user. The expansion subsequently fills the interdental space and increases the attachment of the floss surface to the plaques, making the removal of plaques easier and preventing abrasions and physical damages that would occur otherwise by forceful usage of traditional floss, addressing the problems mentioned before. Furthermore, the star shaped interwoven microfilaments increase the surface area of floss even more which enhances the plaque adherence, II is important to note that the expansion of our floss prevents contamination of the inner filaments with bacteria, inhibiting the saturation of the filaments with bacteria and limiting the problems mentioned before. Furthermore, the surface of the expandable surface is also coated with therapeutic agents such as anti-inflammatory agents, which would offer benefits to individuals with specific conditions and prevent gum swelling and bleeding to some degree. The floss is contained in a special tray holder, which isolates the floss from moisture and contaminants outside, preventing the expansion of the floss inside. This is done through placement of isolating materials surrounding the outgoing floss on the opening orifice of the tray. Furthermore, the case features a U-shaped fork head, as illustrated in the figures that enables ease of use of the floss periodically for each interdental space. The U-shaped fork enables ease of access to the target area and minimizes the contact between floss and user, eliminating the need of inserting fingers into mouth area, creating an easier and more pleasant user experience. Furthermore, the U shape head allows for usage of multi-floss threads simultaneously, up to three, which is a method to adjust for different interdental width in different users.

In accordance with the preferred embodiment, the material in the floss includes a hydrophobic core, made from conventional wax. The surface coating includes expandable hydrophilic water absorbing agent, preferably polyacrilic or its derivatives.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a of a segment of the floss in its unexpanded form;

FIG. 2 is a close up of the surface area of the floss in its unexpanded state;

FIG. 3 is a close up of the surface area of the floss in its expanded form.

FIG. 4 shows the tray holder from an aerial view.

FIG. 5 is a close up of the U shape fork at end terminal of the holder.

FIG. 6 is a close up of the U-shape terminal featuring two floss threads.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

[00:22] The utility model proposes a dental floss holder with the expandable floss. The preferred allowed for the usage of the floss either through conventional method of flossing or through using the included floss holder through details of the inventions and using the floss holder. Some preferred embodiments may be designed to enable them to be produced from the plastic and wax with existing technologies used for manufacturing containers for conventional dental flosses and tapes. However, some alternate embodiments may be produced using different techniques and from different materials including, not limited to, metals, composites, rubber, and or combination of materials. Some preferred embodiments comprise a few parts which allow for easier access and quicker installation of floss and ensuring minimum costs in the production of the device.

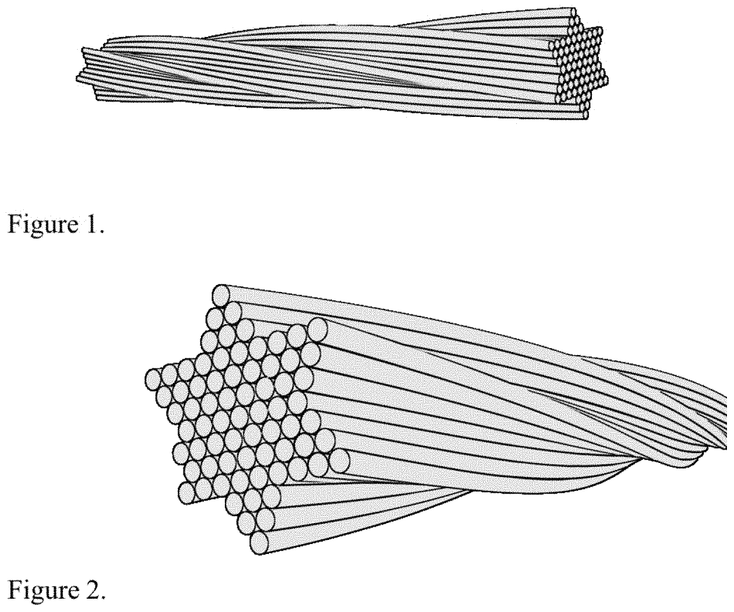

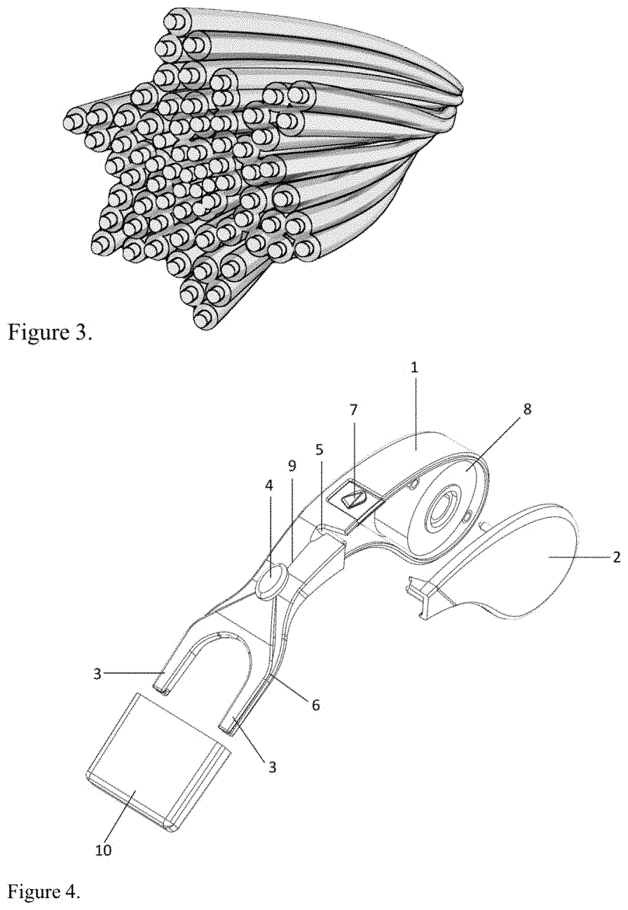

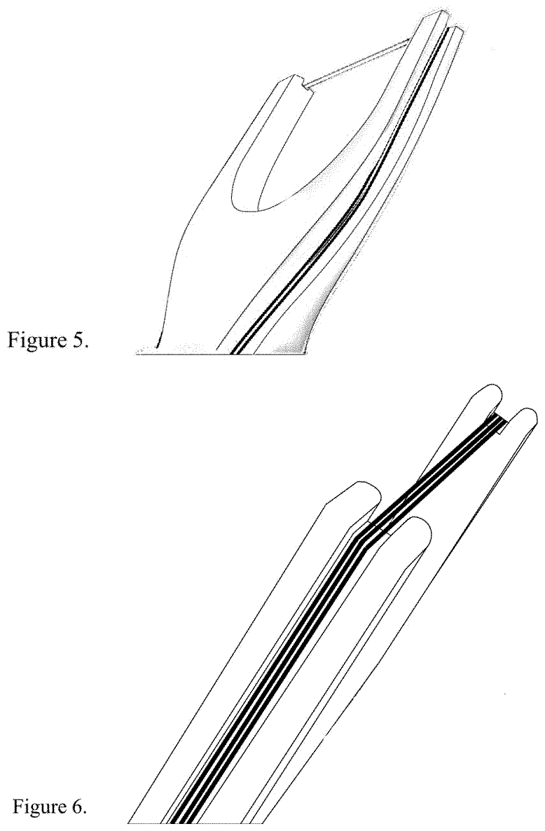

FIGS. 1, 2 and 3 illustrate the novel floss at different stages of use, in accordance with an embodiment of the present invention. FIG. 1 is a diagrammatic side view of the floss, demonstrating an unexpanded segment of the floss. FIG. 2 is a diagrammatic view of the cross section of the novel floss at its unexpanded state, and FIG. 3 is a diagrammatic view of the cross section of the floss at its expanded stage. In the present embodiment, the expandable floss is preferably made for the accompanying novel isolating floss holder. However, it could also be used in conventional flossing without the need of the novel floss holder. It should be noted that the usage of floss without the novel floss holder may compromise the expandability of the floss if it comes in contact with moisture. The present invention also embodies novel isolating floss holder illustrated in FIGS. 4, 5 and 6. FIG. 4 is a diagrammatic view of the isolating floss holder with different parts embodying the invention. FIG. 5 is a diagrammatic view of the U terminal of the floss holder illustrating the novel feature of multiplying the floss at the terminal. FIG. 6 is a diagrammatic view of the U terminal of the floss holder illustrating the same feature of multiplying the floss at the terminal, while with three floss present at the end.

A preferred embodiment of the present invention and variations of thereof provide a dental floss holder with the expandable floss. The preferred allowed for the usage of the floss either through conventional method of flossing or through using the included floss holder through details of the inventions and using the floss holder. Some preferred embodiments may be designed to enable them to be produced from the plastic and wax with existing technologies used for manufacturing containers for conventional dental flosses and tapes. However, some alternate embodiments may be produced using different techniques and from different materials including, not limited to, metals, composites, rubber, and or combination of materials. Some preferred embodiments comprise a few parts which allow for easier access and quicker installation of floss and ensuring minimum costs in the production of the device.

The present invention will now be described in detail with reference to embodiments thereof as illustrated in the accompanying drawings. FIG. 1 demonstrates a segment of the dental floss at its unexpanded state, adjusted for delivery. At this state, the floss is not yet ready for correct usage. The floss is at this stage before being placed in interdental spaces and coming in contact with saliva. The floss container at this stage remains isolated from moisture by the tray holder in FIG. 4, described in detail later. The floss at this stage is dispensed from the tray holder and held in place at the U shape fork, ready to be used. In addition to the U-shaped terminal, the floss at this stage could be dispensed through the cutter placed on the container for traditional flossing by hand, if desired by user. It should be noted that the hydrophilic coating is present on the surface of the filaments, however it has not yet reached its expanded state. An appropriate width for the tape at this stage would approximately be 1.0-1.5 mm.

FIG. 2. exhibits the cross section of the floss at its initial unexpanded state. The hexagram shape increases the surface area of the floss in interdental spaces, leading to more plaque clearance in interdental spaces. The vowing technique of vowing the filaments in the hexagram shape also increase the amount of filament to surface ratio of the floss, which also allows for more coatings to be done on the filaments, increasing the floss's ability to expand.

FIG. 3. shows the same floss as in FIG. 1 that has undergone expansion and made ready to use. The expansion of the cross-section of the floss occurs due to the hydrophilic coating around the filaments of the floss. The hydrophilic coating of the floss subsequently expands by absorbing saliva in interdental spaces. The expanded state of the floss has increased surface area and more surface tension in the interdental spaces. The increased tension in the interdental space increases the plaque attachment to the floss. The floss after turning into its expanded state and being used in interdental spaces can be disposed using the cutter placed on the main body of the container and the new unexpanded floss is replaced in its place at the U shape terminal.

FIG. 4 demonstrates the special tray-holder for the floss mentioned above. The main body 1, terminating at one end in a fork shape with U shape arms 3. The U shape terminal of the apparatus 3 is inclined relative to the body 1 in an angle of 90°. The arms of the U-shaped terminal 3 are symmetrical in respect to the longitude axis of the body. The opening on top of the body 5 is secured with isolating polymers around the exiting floss from the holder so it prevents the entering of moisture into the main body 1. The unexpanded floss is contained in the reel 5 inside the main body 1. The isolated opening of the container is essential feature of the floss container, which prevents the floss to expand while it is held in its reel, Isolating feature of the opening also allows for additional coatings to be applied to the surface of the filaments that otherwise would be sensitive to temperature and moisture which otherwise would evaporate from the reel. The ergonomic shape of the floss with its angled terminal allows easy delivery of the floss into oral cavities and change the floss for easy use. The U shape terminal of the container limits the contact of hand with the floss further limiting bacteria contamination.

The unexpanded floss originated from reel 8, which come out of the main body 1 from the hole on top 5, goes into the U shape head terminal 3 and then wraps around the knob 4 on the top of the body 1. The used floss in its expanded state could be discarded using the cutter located on top of the body 7. During use, a piece of floss of this type is expanded at least once during the complete cleansing of all the interdental spaces. It must therefore be changed at least once during each use. This changing operation consists of unwinding and pulling off a sufficient length of floss out of container, then twisting and fixing it around the stop button, after that passing it through the passage of either two arms, and then reaching to the second arm, and coming back to the stop button again through the passage of that arm, and finally twisting and fixing the floss around the stop button again

The side section of the floss container 2 contains transparent material which allows for easy observation of the floss left for use. The knob 4 on top of the container allows for easier storage of the floss that is intended to use, through which the user can wrap the intended length around the knob 4 and continuously exchange the floss without the need to release the floss from the reel and exposing unwanted amounts to air. The knob 4 mechanism acts to fixate the floss on the U shape head. This also allows for a novel mechanism of multi-layering of the floss at the U terminal. Through this mechanism, the users can wrap the floss multiple times around the knob 4 and through the U shape head, which puts up to 3 times the floss at the U terminal. FIG. 5 demonstrates the U terminal in which the user had placed two layers of floss for usage. FIG. 6 demonstrates the same mechanism at the U shape fork in which the user has allocated 3 layers of floss. This allows for better plaque absorption and clearance through a method which is customizable by the user for optimal width and based on the desired interdental space. This mechanism allows for an enhanced plaque absorption based on the users' individual interdental spaces.

The supportive properties that distinguish the device at hand in accordance with the invention are partly due to the expandability of the floss due to its coating, the hexagram cross section of the floss with interwoven filaments, and due to special holder isolating the floss from outside. The manufacturing of the tape with a hydrophobic core with an initial coating of expandable hydrophilic material, with width of 1.0 to 1.5 mm, is achieved in a hexagram cross section with a circular threading technique that compresses the filaments into an interwoven thread. The width of the floss after absorbing water would then be increased to 2.0 to 2.5 mm.

As mentioned above, the floss includes a hydrophilic coating which is made from Polyacrylic polymers and its derivatives which expand upon coming in contact with solutions such as saliva. The expansion of the filaments due to its coating would subsequently increase its cross section and surface area which would result in more plaque attachment to the floss.

Additionally, since the filaments of the thread expand beyond their initialwidth, bacteria and plaque are not able to penetrate into the floss and thus they are not carried deep into interdental spaces. The isolating features of the case allows for the coating of hydrophilic agents to contain anti-inflammatory agents that would prevents gum inflammation or easier flossing for individuals with certain diseases such as diabetes.

Our testing of polyacrylic hydrophilic agents in the laboratory have demonstrated that the expansion of this class of materials is due to water in the saliva, and digestive enzymes would not interfere with this action. Furthermore, our studies and prior data shows that their toxicity to be non-existent to human cells, making them an excellent candidate for expandable coating.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) The invention is a floss with a hydrophobic core that has a fixed surface area, encapsulated by a hydrophilic coating that expands as it comes in contact with saliva;
a) The expansion of claim 1, occurs in the interdental cavities after being placed for a short period of time by the user;
b) The expansion of claim 1, fills the interdental space and increases the attachment of the floss surface to the plaques, making the removal of plaques easier and preventing abrasions and physical damages;
c) The expansion of claim 1, prevents contamination of the inner filaments with bacteria, inhibiting the saturation of the filaments with bacteria.

2) star shaped interwoven microfilaments increase the surface area of floss even more which enhances the plaque adherence.

3) a special tray holder, which isolates the floss from moisture and contaminants outside, preventing the expansion of the floss inside.

4) U-shaped fork enables ease of access to the target area and minimizes the contact between floss and user, eliminating the need of inserting fingers into mouth area.
